(19) United States
(12) Patent Application Publication
(10) Pub. No.: US 2023/0337758 A1
(43) Pub. Date: Oct. 26, 2023

(54) Fabric and Garment Comprising Discrete Islands of Retroreflective Laminate

(71) Applicant: 3M INNOVATIVE PROPERTIES COMPANY, St. Paul, MN (US)

(72) Inventors: Ying Xia, Woodbury, MN (US); Shri Niwas, Maple Grove, MN (US); Michael A. McCoy, St. Paul, MN (US); Lok-Man Ng, Hsinchu City (CN)

(21) Appl. No.: 18/025,369

(22) PCT Filed: Sep. 20, 2021
(86) PCT No.: PCT/IB2021/058553

§ 371 Date: Mar. 8, 2023

Related U.S. Application Data
(60) Provisional application No. 63/082,616, filed on Sep. 24, 2020.

(51) Int. Cl. A41D 13/01; A41D 31/14; A41D 31/32

(52) U.S. Cl. CPC A41D 13/01; A41D 31/145; A41D 31/325

(57) ABSTRACT

A breathable, high-visibility garment comprising discrete islands of unsupported, retroreflective laminate.

### BACKGROUND

Retroreflective materials have been developed for a variety of applications. Such materials are often used e.g. as high-visibility trim materials in clothing to increase the visibility of the wearer. For example, such materials are often added to garments that are worn by firefighters, rescue personnel, road workers, and the like.

### SUMMARY

In broad summary, herein is disclosed a breathable, high-visibility garment comprising a breathable fabric and discrete islands of unsupported, retroreflective laminate that are adhesively bonded to an outer major surface of at least one region of the breathable fabric. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a front view of an exemplary high-visibility garment bearing exemplary discrete islands of retroreflective laminate in selected regions of the garment.

FIG. 2 is a front-view photograph of a Working Example exemplary breathable fabric, bearing exemplary discrete islands of retroreflective laminate in selected regions of the fabric.

FIG. 3 is a magnified view of exemplary discrete islands of retroreflective laminate.

FIG. 4 is a side cross-sectional view of a portion of an exemplary breathable fabric bearing exemplary discrete islands of retroreflective laminate.

FIG. 5 is a side cross-sectional magnified view of a portion of an exemplary fabric bearing an exemplary retroreflective laminate.

FIG. 6 is a side view of an exemplary lamination process for disposing discrete islands of retroreflective laminate onto a fabric.

FIG. 7 is a perspective view of an exemplary netting that may be useful as a stencil for a lamination process.

FIG. 8 is a perspective view of another exemplary netting that may be useful as a stencil for a lamination process.

Like reference numbers in the various figures indicate like elements. Some elements may be present in identical or equivalent multiples; in such cases only one or more representative elements may be designated by a reference number but it will be understood that such reference numbers apply to all such identical elements. All non-photographic figures and drawings in this document are not to scale and are chosen for the purpose of illustrating different embodiments of the invention. The dimensions of the various components are depicted in illustrative terms only, and no relationship between the dimensions, relative curvatures, etc. of the various components should be inferred from the drawings. In particular, the thicknesses of reflective layers in proportion to certain other items are exaggerated for ease of illustration.

As used herein, terms such as “outward”, “outer”, and the like, as applied to garments, fabrics, retroreflective laminates borne by such fabrics, and so on, refer to the side from which the item will be viewed; that is, the side away from the wearer's body. Terms such as “inner”, “inward”, and the like, refer to an opposing side; that is, the side that faces toward the wearer's body. Terms such as upward and downward have the usual meaning with regard to a vertical axis established by a wearer of a garment (i.e., a person) standing upright. (The inward-outward directions (i-o) and upward-downward directions (u-d) are indicated in various Figures.) Even for specific items and components (e.g. binder layers, adhesive layers and so on, that are part of a retroreflective laminate), this terminology is with reference to the garment as a whole rather than to the specific item, unless otherwise specified.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). The term “substantially”, unless otherwise specifically defined, means to a high degree of approximation (e.g., within +/−10% for quantifiable properties). The term “essentially” means to a very high degree of approximation (e.g., within plus or minus 2% for quantifiable properties); it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter. All averages referred to herein are number-average unless otherwise specified.

### DETAILED DESCRIPTION

Disclosed herein is a breathable fabric 10 and a high-visibility, breathable garment 1 that can be made from such a fabric. By a garment is meant an item that, in normal use, is to be donned and worn by a person. By definition, the term garment excludes any item that is itself to be attached to a garment that is to be donned and worn by a person. Thus, the term garment excludes “trim” items of the general type described later herein.

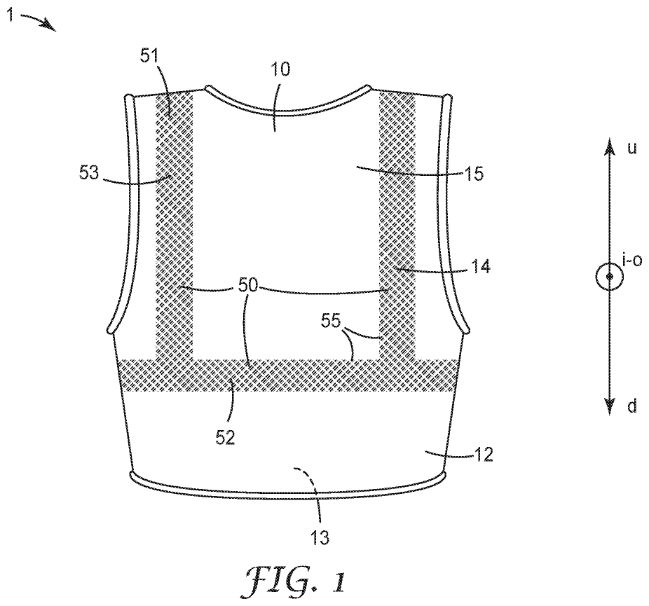

An exemplary high-visibility, breathable garment 1 in the form of a vest is depicted in FIG. 1. In general, such a garment may take the form of e.g. a vest, jacket, shirt (long-sleeve or short-sleeve), trousers, coverall, and the like. Such a garment will comprise an outer major surface 12, much or all of which is visible when the garment is worn; and, an inner major surface 13 that faces toward the wearer's body and much or all of which may not be visible when the garment is worn.

Such a garment 1 will comprise one or more macroscopic regions 14 that are retroreflective so as to impart high visibility. In many embodiments, some regions 14 of fabric 10 of garment 1 may be retroreflective, with other regions 15 of fabric 10 not being retroreflective. For example, retroreflective regions 14 may take the form of one or more vertical stripes 51 and one or more horizontal stripes 52, as in the exemplary design of FIG. 1. At least some such retroreflective areas will be provided by a retroreflective laminate 50, as defined and described in detail herein.

By a “macroscopic” retroreflective region 14 is meant a retroreflective region with an overall size of at least 50 square mm. In various embodiments, such a region as present on a garment may have a size of at least 100, 150, or 200 square cm. The size of any such region will be evaluated based on the outer perimeter of the macroscopic region, notwithstanding that the retroreflective laminate within the region will be provided in the form of discrete islands. For example, such a retroreflective region 14 may take the form of a stripe, in the general manner shown in FIG. 1. (In various embodiments, such a stripe may comprise a width of at least 25, 35, or 50 mm.) The size of any such rectangular stripe will be the length times the width. The size of other regions of other shapes can be calculated using the algorithm appropriate for that shape.

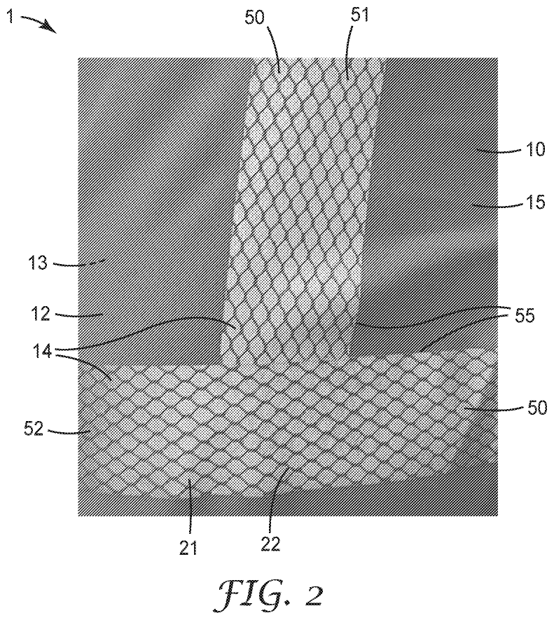

A macroscopic retroreflective region 14 will have edges 55 that demarcate area 14 that includes discrete islands 21, from region 15 that is free of islands 21. In some embodiments, a retroreflective region 14 may be separated from another retroreflective region 14 by an area, e.g. a macroscopic area, in which the breathable fabric 10 is visible. Or, in some embodiments, an edge 55 of a retroreflective region may be closely abutted against an edge 55 of another retroreflective region (e.g. as for the vertical and horizontal retroreflective stripes 51 and 52 as shown in FIG. 1, and for the two retroreflective regions 14 visible in the photograph of a Working Example sample shown in FIG. 2). In some embodiments, a retroreflective region 14 may extend continuously e.g. around sleeves, trouser legs, or other components of the garment. Many such arrangements are possible.

In various embodiments, the retroreflective regions 14 may collectively make up at least 2, 4, 8, 10, 20, 30, or 40 percent of the total area of the outer major surface of the fabric of the garment. In further embodiments, the retroreflective regions 14 may make up at most 90, 80, 70, 60, 50, 45, 35, 25, or 15 percent of the total area of the outer major surface of the fabric of the garment. (In some embodiments, essentially the entirety of the outer surface of the fabric may be retroreflective.)

Discrete Islands

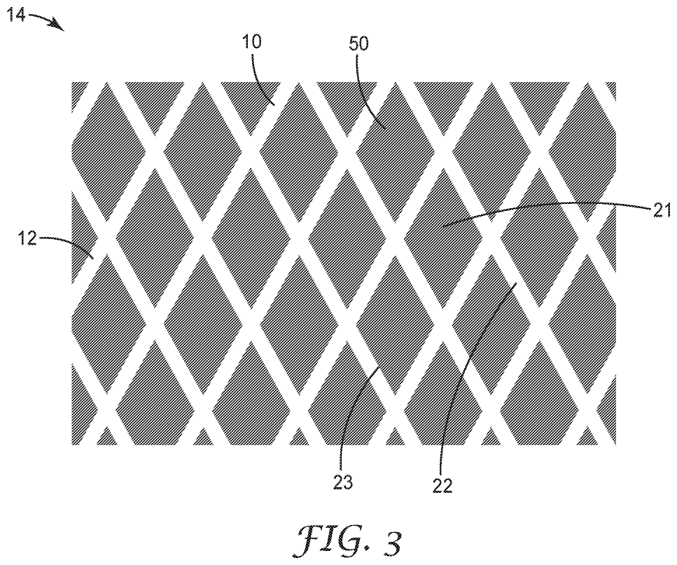

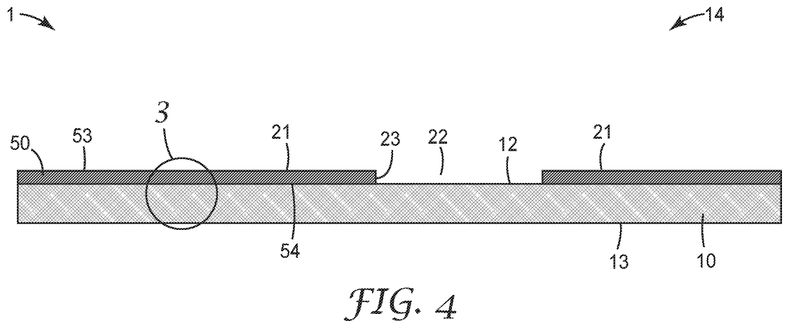

A macroscopic retroreflective region 14 of a garment will be retroreflective by way of the presence of a multiplicity of discrete islands 21 of retroreflective laminate 50, as illustrated in FIGS. 1 and 2 and in the magnified view of FIG. 3. By discrete islands is meant that retroreflective laminate 50 is present in the form of numerous individual, small-scale pieces 21, each of which is surrounded on all sides, and separated from its nearest-neighbor pieces, by empty spaces 22. The exposed outer major surface 12 of breathable fabric 10 will typically be visible in empty spaces 22, as indicated in FIGS. 3 and 4. These numerous small-scale pieces 21 of retroreflective laminate 50 will collectively provide the retroreflectivity that is exhibited by macroscopic retroreflective regions 14 of garment 1.

Within any given macroscopic region 14, the discrete islands 21 of retroreflective laminate 50 will be present at an areal density of at least 60% and at most 95%. The areal density is calculated by dividing the cumulative area of region 14 that is covered by retroreflective islands 21, by the total area of region 14. (By way of a specific example, the discrete islands 21 of retroreflective laminate 50 in the Working Example sample shown in FIG. 2 are present at an areal density in the range of approximately 80%.) In various embodiments, islands 21 may be present at an areal density of at least 65, 70, 75, or 80%. In further embodiments, islands 21 may be present at an areal density of at most 90, 85, or 80%. In still further embodiments, islands 21 may be present at an areal density of 60 to 70%, >70 to 80%, or >80 to 90%. The present work has revealed that such areal densities can allow the regions 14 to exhibit sufficient retroreflectivity, while also exhibiting sufficient breathability.

By definition, the discrete islands 21 of retroreflective laminate will exhibit an average size of from 1 square mm to 100 square mm. In various embodiments, the discrete islands 21 may exhibit an average size of at least 2, 4, 8, 20, or 40 square mm. In further embodiments, the discrete islands 21 may exhibit an average size of at most 80, 60, 40, or 30 square mm. In some embodiments, the discrete islands may exhibit sizes that are relatively uniform (e.g. as in the exemplary arrangement presented in the photograph of FIG. 2.) In other embodiments, the discrete islands may vary considerably in size. The discrete islands may be present in any suitable arrangement or pattern, e.g. in a square array, a hexagonal array, a nonuniform or irregular array, and so on.

As noted, each discrete island 21 will be surrounded on all sides, and separated from its nearest-neighbor islands, by gaps (empty spaces) 22. In various embodiments, such gaps may be, on average, at least 0.3, 0.5 or 1.0 mm wide. In further embodiments, such gaps may be, on average, at most 5.0, 4.0, 3.0, 2.0, or 1.5 mm wide. In various embodiments, such gaps may be relatively uniform or may vary somewhat. (If gap 22 varies in width, the average width may be obtained by measuring the gap width at a suitable number of locations (e.g. 10) spaced along the elongate extent of the gap.)

The size and shape of discrete islands 21 of retroreflective laminate 50, the width of gaps 22 therebetween, the areal coverage exhibited collectively by the islands, and the pattern in which the islands are present, may be dictated by choosing the parameters of a stencil that is used in the process of laminating the retroreflective laminate 50 to a fabric, as discussed in detail later herein.

Breathable Fabric

Fabric 10 of garment 1, at least in areas of the fabric that do not comprise any retroreflective laminate 50 thereon, will be breathable. By breathable is meant that fabric 10 exhibits a moisture-vapor transmission rate (MVTR) of at least 2000 grams per square meter per 24 hours. Such an evaluation of MVTR will be performed at a temperature of 38° C. in an “upright” configuration (in contrast to an “inverted” test configuration in which liquid water is in direct contact with the tested layer) in generally similar manner as disclosed in U.S. Pat. No. 5,981,038 to Weimer, which is incorporated by reference herein for this purpose. Such methods are also discussed in U.S. Patent Application Publication 2011/0112458 (Test Method 1A), which is also incorporated by reference herein for this purpose.

In various embodiments, fabric 10 may exhibit an MVTR of at least about 3000, 4000, 5000, 8000, 10000, or 15000 grams per square meter per 24 hours when tested in this manner. Such breathability can provide that, at least in most normal conditions, any sweat that is exuded by the skin of the wearer of the garment, can be transported as water vapor away from the skin at a rate sufficient to maintain the skin in a satisfactorily dry condition. In further embodiments, the MVTR may be at most 40000, 30000, or 20000 grams per square meter per 24 hours.

In some embodiments, the breathability of fabric 10 may be an inherent property of the fabric, e.g. that is controlled by the composition of the material of which the fabric is made (e.g., fabrics made of cotton or a cotton blend may be more breathable than a fabric made of polyolefin), by the presence of any interstitial spaces between fibers of the fabric as made (e.g., a fabric with a relatively loose weave may be more breathable than a fabric with a relatively tight weave), and so on. However, in some embodiments the fabric 10 may comprise e.g. perforations that are achieved by post-processing the fabric; in such cases the perforations may contribute to (and in some instances may dominate) the breathability of the fabric.

The above-cited values may apply to fabric 10 as originally made (including any post-processing step to impart perforations) and to macroscopic regions 15 of fabric 10 that do not comprise any islands 21 of retroreflective laminate 50. It will be appreciated that the presence of the islands 21 of retroreflective laminate 50 in a macroscopic region 14 of fabric 10 may reduce the overall MVTR exhibited by that region. In some embodiments, the MVTR of a region 14 may scale approximately with the percent open-fabric area of the region 14. The percent open-fabric area will be 100 percent minus the above-described areal density of the islands of retroreflective laminate 50 in that region 14. By way of a specific example, if the areal density of a region 14 is 80%, the percent open-fabric area will be 20%; in some such cases, the MVTR exhibited by the region 14 may be in the approximate range of e.g. 10-30% of the MVTR of the fabric 10 itself.

Since in many embodiments the retroreflective regions 14 may occupy a rather small (e.g. less than 40%) percentage of the total area of fabric 10 of garment 1, it may not be necessary that retroreflective regions 14 exhibit an MVTR that is as high as that of the native fabric. Rather, all that may be needed is that retroreflective regions 14 exhibit sufficient MVTR to avoid forming localized hot or sweaty spots of the garment. In various embodiments, a region 14 bearing discrete islands 21 of retroreflective laminate 50 may exhibit an MVTR of at least about 1000, 2000, 4000, 5000, or 8000 grams per square meter per 24 hours. (Of course, if a particular region 14 comprises apertures that are not occluded by the retroreflective laminate 50, as discussed below, such a region 14 may actually exhibit an MVTR that is quite close to that of the native fabric, e.g. 10000 or even 15000 grams per square meter per 24 hours.)

Another well-known measure of breathability is the so-called Water Vapor Resistance (Ret) Test, performed according to the general procedures provided in ISO Test Standard 11092 as specified in 2014. Such an evaluation provides an “Ret”, with lower values of Ret corresponding to lower water-vapor resistance and thus higher breathability. In various embodiments, a fabric 10 and/or a retroreflective region 14 of a fabric 10, may exhibit a Ret value of greater than (>) 20, of >13 to 20, of >6 to 13, or of >0 to 6.

As noted above, in some embodiments the breathability of a fabric 10 may be inherent in the fabric as made, e.g. due to the composition of the material of which the fabric is made and/or to the presence of interstitial spaces between fibers of the fabric as made. In some embodiments, the breathability may be at least partly due to the presence of apertures in the fabric. By an aperture is meant a through-opening (through-hole) that extends through the thickness of the fabric 10 from outer major surface 12 to inner major surface 13. By definition, in order to quality as an “aperture”, such a through-opening must exhibit a size (area) of at least 0.3 square millimeters. An aperture as defined herein thus does not encompass very small interstitial spaces between fibers.

A fabric 10 may thus be an unapertured fabric or an apertured fabric. While any fabric may occasionally comprise a few large holes due to occasional defects as may occur in any real-life manufacturing process, an unapertured fabric as defined herein will not comprise a statistically meaningful number of through-openings of the minimum size stated above. For the purposes herein, the cut-off between an apertured fabric and an unapertured fabric is that an apertured fabric must comprise a sufficient number and/or size of apertures to provide the fabric with a minimum of 3 percent open area.

As will be discussed in detail later herein, a retroreflective laminate 50 will be adhesively bonded to the major surface 12 of the breathable fabric 10. In general, any small interstitial spaces or openings that are present at the outer major surface 12 of the fabric, will be bridged over, and occluded, by a retroreflective laminate 50 that is disposed on that particular area of the fabric. Thus, in many embodiments involving an unapertured breathable fabric 10, a retroreflective laminate 50 will occlude the local area of the fabric that the laminate is disposed on and thus will reduce the breathability of that local area. In contrast, in at least some embodiments, any apertures that are present will not be bridged over or occluded by a retroreflective laminate but rather may remain open. Such unoccluded apertures can provide enhanced breathability even in regions 14 of fabric 10 that bear retroreflective laminates 50. Arrangements by which a retroreflective laminate may be laminated onto an apertured fabric without occluding the apertures, are described in detail in U.S. Provisional Patent Application 63/082,841, entitled Retroreflective Apertured Fabric and Garment, attorney docket number 83371US002 and filed evendate herewith, which is incorporated by reference in its entirety herein.

Broadly speaking, an aperture may be of two general types, provided in two general ways. A first type is an aperture that is inherently present as a sufficiently large space between filaments (with the word “filaments” broadly embracing threads, strands, yarns and so on) of a textile fabric such as e.g. a woven or knitted fabric. In other words, in some embodiments a fabric may be e.g. a loosely-woven textile in which at least some spaces between warp and weft filaments are sufficiently large to qualify as apertures. (Such apertures may be e.g. generally square in shape when viewed along the inward-outward axis of the fabric, depending on the particular nature of the weave.) This type of aperture, which will result inherently from the process of manufacturing the fabric and will not necessarily require any kind of post-processing to form the aperture, will be referred to as an “interstitial” aperture. (However, it is noted that only openings that exhibit the minimum size (area) referred to above, will qualify as “apertures”.) Any such fabric that comprises interstitial openings of such size as to qualify as interstitial apertures will be referred to herein as a “mesh”. In any real-life mesh, some openings may be large enough to qualify as apertures, while others may not.

A second type of aperture is a perforation, which by definition is an aperture that is formed in the fabric by way of a post-process performed after the initial production (e.g. by weaving) of the fabric. Such a post-process might be e.g. mechanical perforation (e.g. by die-cutting), water-jet cutting, laser-cutting, needle-punching, and so on. In such cases, the shape of the aperture may be established by the particular method and equipment used, e.g. round, oval, square, hexagonal, and so on. In some embodiments, a combination of interstitial apertures and perforations may be present (in other words, in some embodiments a “mesh” may be perforated).

In various embodiments, any such apertures, however formed, may occupy a percent open area of at least 3, 5, 10, 15, or 20%. In further embodiments, such apertures may occupy a percent open area of at most 50, 45, 40, 35, 30, 25, 18, 13, or 8%. In general, the upper limit on the percent open area may be established by the desired visibility that the fabric is to achieve. In particular, if it is desired that the fabric is to meet the criteria set out in ANSI ISEA 107-2015 American National Standard for High-Visibility Safety Apparel and Accessories (hereafter, “ANSI 107-2015”), the % open area may need to fall below a certain limit in order to meet the luminance requirements of the ANSI 107-2015 standard. In various embodiments, the apertures of an apertured fabric may exhibit a size of at least 0.5, 1.0, 1.5, or 2.0 square mm; in further embodiments, the apertures may exhibit a size of at most 20, 15, 10, 8, 6, 5, 4, 3, or 2.5 square mm. The maximum size of an aperture will be 100 square mm. It is noted that in order to be considered apertures, any such openings must be present in large number; occasional openings such as buttonholes, stitch-holes, and so on, will be disregarded.

Breathable fabric 10 may be of any suitable composition and may be made by any suitable process. For example, fabric 10 may be made of e.g. polyester, a polyester/cotton blend, cotton, nylon, and so on. If it is desired that the fabric exhibit heat-resistance and/or flame retardancy as may be beneficial for a particular use, the fabric may include, or be made of, well-known materials such as the products available under the trade designations KEVLAR and NOMEX, CELAZOLE, and PBI-LP. In some embodiments, such a fabric may be e.g. a textile, e.g. a woven or non-woven textile or similar material. However, broadly speaking, any sheet-like material that is suitable for use as a garment, made by any process, may qualify as a fabric.

In some embodiments, the breathable fabric may be a stretchable fabric, by which is meant that the fabric can be reversibly stretched to an elongation of at least 50% without the fabric undergoing any significant permanent deformation or damage. Such fabrics may, for example, comprise a blend of spandex or elastane fibers with other fibers. In various embodiments a stretchable fabric may be reversibly stretchable to an elongation of at least 100, 150 or 200%. The present work has revealed that the disposing of discrete islands of retroreflective laminate on such a fabric, need not necessarily reduce the stretchiness of the fabric unduly. Thus, in at least some embodiments, the above-recited elongation values may be exhibited by retroreflective regions 14 of such a fabric.

In many embodiments, a garment 1 may comprise a fabric 10 that is present as a single layer over e.g. at least 60, 70, 80, 90, or 95% of the total area of the garment. That is, except for such areas in which seams, cuffs, lapels, waistbands, liners or the like may be present, the majority of the garment may take the form of a single layer of fabric 10. Such a single layer will be distinguished from a garment that comprises a stack of multiple layers of fabric. (However, in this context, a single layer of fabric will encompass, for example, a layer of fabric that bears a coating e.g. for purposes of water-repellency.) In some embodiments, a fabric may be a multilayer fabric, e.g. in which separate, pre-made fabric layers are attached to each other e.g. by lamination. In such embodiments, the fabric layers should be arranged or processed so that sufficient breathability is maintained.

In many embodiments breathable fabric 10 may be fluorescent. By “fluorescent” is meant that the fabric (and garment 1 made therefrom) will exhibit a luminance (minimum luminance factor) that meets the criteria set out in ANSI 107-2015. Those of ordinary skill will know that such minimum values vary depending on the particular fluorescent color (for example, a fluorescent yellow fabric must exhibit a minimum luminance factor of 0.70). This may be achieved e.g. by incorporating one or more fluorescent additives into the fabric (e.g. into the filaments that form the fabric). Such fluorescent additives and fabrics are widely available. In such embodiments, the garment may exhibit e.g. bright yellow, orange or green fluorescent areas interspersed with retroreflective areas (e.g. stripes). In the Working Example sample whose photograph appears in FIG. 2, regions 15 of fabric 10 that do not have a retroreflective laminate 50 thereon, exhibit the bright fluorescent orange color of the original fabric, although this is not visible in the grey-scale photograph of FIG. 2. In this sample, regions 14 exhibit (in ambient light) the light-silver color that is characteristic of many retroreflective layers.

Retroreflective Laminate

As disclosed herein, at least one retroreflective area of a garment 1 will be provided by a retroreflective laminate. The side cross-sectional view of FIG. 4, depicted in exemplary, generic representation, depicts portions of two discrete islands 21 of retroreflective laminate 50 that are disposed in a region 14 of a breathable fabric 10. Gap 22, in which major surface 12 of fabric 10 is visible, is present between islands 21.

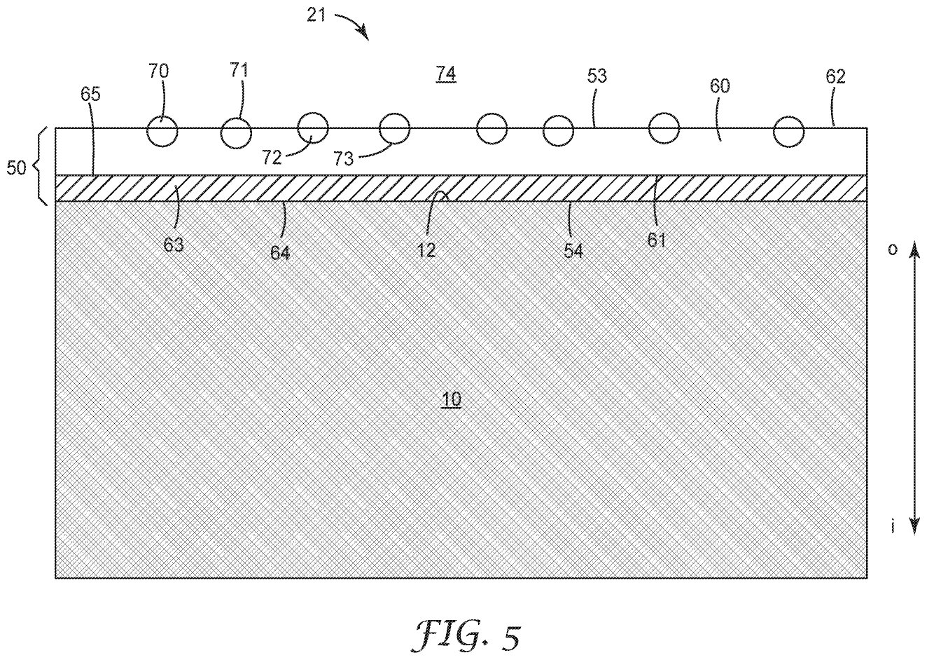

FIG. 5 is a magnified view of a section of fabric 10 bearing a portion of an exemplary discrete island 21 of retroreflective laminate 50. In many embodiments, such a retroreflective laminate 50 may comprise a binder layer 60, transparent microspheres 70, and an adhesive 63. Adhesive 63 may be conveniently in the form of a continuous layer as shown in FIG. 5; however, in some embodiments such an adhesive may be provided discontinuously e.g. by spraying.

Any such discrete island 21 of laminate 50 will provide a plurality of retroreflective elements spaced over the length and breadth of a front side of binder layer 60 of the island 21. Each retroreflective element will comprise a transparent microsphere 70 that is partially embedded in binder layer 60 so that portions 71 of microspheres 70 are partially exposed. Binder layer 60 holds and retains transparent microspheres 70 and presents them in such a manner that they can exert a retroreflective effect, and provides the retroreflective laminate 50 with sufficient mechanical integrity to be processed and handled.

Each transparent microsphere 70 has an embedded portion 72 that is seated in binder layer 60. A minor reflective layer 73 will be disposed between the embedded portion 72 of microsphere 70 and the binder layer 60. The microspheres 70 and the minor reflective layers 73 collectively return a substantial quantity of incident light towards the light source. That is, light that encounters the retroreflective laminate's outer side passes into and through microspheres 70 and is reflected by minor reflective layers 73 to again reenter the microspheres 70 such that the light is steered to return toward the light source, in the general manner signified by the term “retroreflection”.

Retroreflective laminate 50 includes an adhesive 63 as noted above. In the exemplary depiction of FIG. 5, an inner major surface 64 of adhesive layer 63 is in contact with an outer major surface 12 of fabric 10. An outer major surface 65 of adhesive layer 63 is in contact with an inner major surface 61 of binder layer 60. In the depicted embodiment, an outer major surface 62 of binder layer 60 will provide the outer major surface 53 of laminate 50 (disregarding the protruding portions 71 of microspheres 70); an inner major surface 64 of adhesive layer 63 will provide the inner major surface of laminate 50.

As noted, a retroreflective assembly that is provided as disclosed herein is a retroreflective laminate 50. By a laminate is meant a pre-existing stack (e.g. including a microsphere-bearing binder layer 60 and an adhesive layer 63, as described above) that is to be adhesively bonded as a whole to a fabric 10, by way of the adhesive layer 63 of the laminate. By definition, adhesive layer 63 is a component of retroreflective laminate 50 prior to being brought into contact with fabric 10. Such an arrangement will thus be distinguished from, for example, an approach in which an adhesive is disposed onto a fabric (e.g. by screen-printing) after which a retroreflective item is brought into contact with the adhesive. Those of ordinary skill will appreciate that the herein-disclosed approach, in which the adhesive layer is a pre-existing component of the retroreflective laminate, will cause the resulting product (a fabric layer bearing the retroreflective laminate) to exhibit at least some features that distinguish this product from one that is obtained by, e.g., screen-printing or otherwise disposing an adhesive layer onto the fabric. A retroreflective laminate as disclosed herein will also be distinguished from, e.g., a retroreflective item formed by e.g. directly coating a retroreflective layer onto a fabric.

Unsupported Laminate

By definition, a retroreflective laminate 50 is unsupported. By this is meant that laminate 50 does not include any kind of supporting substrate, layer, film, or the like (other than binder layer 60), that serves to provide mechanical integrity at the expense of increased thickness of the laminate. In particular, an unsupported laminate 50 does not comprise any layer of fabric or the like. In this respect, the approach disclosed herein differs markedly from many conventional approaches to providing garments with retroreflectivity. For many years, retroreflectivity has been imparted to garments by providing one or more retroreflective items in the form of “trim”; that is, in the form of a retroreflective layer disposed on a layer of supporting fabric. The “trim” is attached to the garment e.g. by sewing, by ultrasonic bonding, by way of an adhesive, or the like. The result is that two layers of fabric are present (the garment fabric, and the trim fabric). This can reduce the breathability of the garment, can increase the local stiffness of the garment, and so on.

In contrast, in the present approach, a retroreflective laminate 50 is provided directly on the fabric of a garment, without the need for any additional supporting fabric layer. Such an approach eliminates the extra thickness that would be imparted by a supporting layer of fabric, minimizes any impact on breathability and stiffness, and minimizes the rough edges that are typically exhibited by retroreflective “trim”. (In some instances, the edges 23 of discrete islands 21 of retroreflective laminate 50 as shown in FIG. 4 may be so subtle that a person might be able to run their finger along the fabric and not be able to easily tell when the edges of the islands are encountered.) Thus in some embodiments, a retroreflective laminate as mounted on a fabric of a garment may provide a “low-profile” retroreflective area in which the local thickness of the retroreflective area (the combined thickness of the garment fabric and the retroreflective laminate) may be greater than the thickness of the garment fabric alone, by a factor of less than 1.5, 1.3, or 1.2. By way of a specific example, in some embodiments a breathable fabric may be e.g. 0.4-0.5 mm in thickness and a retroreflective laminate that is to be laminated to the breathable fabric may be e.g. 0.10-0.15 mm in thickness.

Thus in summary, an unsupported retroreflective laminate as disclosed herein will not include any kind of supporting substrate such as a fabric layer. In some embodiments, such a laminate may consist essentially of, or consist of, two major layers: a binder layer, and an adhesive layer to attach the laminate to a fabric of a garment. In this context a major layer is considered to be a structural layer which, by definition, includes binder layers and adhesive layers. A major layer, by definition, excludes optical layers such as retroreflective layers (e.g. vapor-coated metal layers), and the like (such layers will be termed minor layers herein). The condition that the laminate may consist of these two major layers does not preclude the presence of other components, e.g. microspheres, and/or the presence of other layers that are considered herein to be minor layers.

By definition, a retroreflective laminate as disclosed herein will comprise more than one major layer. For example, in many embodiments a binder layer 60 and an adhesive layer 63 will be present. The adhesive layer 63 and the binder layer 60 are separate layers, that differ in composition and function, with the binder layer providing the retroreflective elements and with the adhesive layer being used to hold the binder layer in place on the desired fabric. Such arrangements are distinguished from those in which a single major layer (e.g. an adhesive layer that itself provides retroreflective elements) is used. Discrete items that provide retroreflective elements, e.g. transparent microspheres, will not be considered to constitute a major “layer” in this context.

In various embodiments a retroreflective laminate (in the absence of any liners) may exhibit a thickness, from its outer surface 53 to its inner surface 54 (e.g. from an outer surface 62 of binder layer 60, to an inner surface 64 of adhesive layer 63, and disregarding any microspheres that protrude above the binder layer) that is from about 20, 40 or 60 microns, to about 300, 200, 150, 100, 80, or 50 microns. In various embodiments a retroreflective laminate may exhibit a thickness, from its outer surface 53 to its inner surface 54 (e.g. from an outer surface 62 of binder layer 60, to an inner surface 64 of adhesive layer 63, and disregarding any microspheres that protrude above the binder layer) that is from about 5, 10, 20, or 30%, to about 80, 60, 50, 40, 35, 25, or 15%, of the thickness of the fabric to which it is attached.

Adhesive

Laminate 50 is adhesively bonded to the outer major surface 12 of a breathable fabric 10, by way of adhesive 63. Adhesive 63 may be of any suitable type that allows the lamination to be performed. In some embodiments such an adhesive 63 may be a pressure-sensitive-adhesive (PSA) at room temperature (21 degrees C.). By definition, such a PSA will meet the well-known Dahlquist criterion of exhibiting a one-second creep compliance of greater than 1×10⁻⁶ cm²/dyne, at 21 degree C.

In other embodiments such an adhesive 63 may be a material that does not exhibit PSA properties at room temperature but can be raised to a temperature (e.g. by performing the lamination in a heated press as described later herein) at which the adhesive bonds to the fabric. Some such embodiments may have the advantage that, if the adhesive is sufficiently non-tacky at room temperature (and at all temperatures to which the adhesive may be exposed during storage, shipping and handling) the adhesive may not need to be covered by a non-stick liner.

In some embodiments, an adhesive may be a material (e.g., a so-called hot melt adhesive) that can be brought up to a temperature at which it can be flowably deposited (e.g. coated or extruded) onto the binder layer, after which it can be cooled to form the adhesive layer. The resulting laminate can be held until such time as it is desired to attach the laminate to a fabric, at which time the adhesive can be heated (e.g. in a platen press as described later herein) to a temperature sufficient to bond the laminate to the fabric.

In some embodiments, an adhesive may be e.g. a thermoplastic material in the form of a film or sheet that can be disposed onto the binder layer by heated lamination rather than by having to fully melt the adhesive material so that it can be disposed on the binder e.g. by coating. The resulting laminate can then be used in similar manner as described above for flowably-deposited hot-melt adhesives. Such materials may have a thickness of, e.g., from 25, 50 or 75 microns, to 150, 125, 100, or 75 microns, and may have a softening point in the range of e.g. 100 to 150 degrees C.

Thus in some embodiments a suitable adhesive may be disposed onto a binder layer, whether by e.g. liquid-coating, spraying, extrusion, or lamination, with the resulting article being stored (with or without a non-stick liner over the adhesive, depending on the characteristics of the particular adhesive) until such time as it is desired to laminate the article to a fabric. In other embodiments a suitable adhesive may be disposed onto the binder layer e.g. by liquid-coating, spraying, extrusion, or lamination, as a part of the lamination process (e.g. immediately before the resulting article is laminated to a fabric).

Various PSAs, hot-melt-flowable adhesives, thermally-activatable adhesive films, and so on, are widely available. Such materials may be made of, or include, e.g. ethylene-vinyl acetate copolymers, acrylate polymers and copolymers, natural rubber polymers, polyolefins, polyamides, polyesters, polyurethanes, polycaprolactones, polycarbonates, styrene block copolymers, and so on. Such materials may be available from suppliers such as e.g. 3M, Bostik (Arkema), Lubrizol, Bemis, Huntsman, Worthen, and Celanese. In some embodiments, the composition of the adhesive may be chosen in view of the fabric that is to be bonded to. For example, an adhesive comprising polyester or the like may be used if the laminate is to be bonded to a fabric that comprises polyester, cotton, a polyester-cotton blend, and so on. Although many such adhesives may be thermoplastic as noted, in some embodiments a thermosettable adhesive may be used, e.g. a reactive hot melt adhesive based on e.g. polyurethanes or polyolefins. Such adhesives are available e.g. from Buhen Adhesive Systems.

In some embodiments, such an adhesive may become sufficiently deformable under the lamination temperature and/or pressure to deform or move slightly in a lateral direction. So, in some instances, an outer edge of a discrete island of retroreflective laminate may be at least partially defined by a small amount of adhesive that may have deformed (e.g. “oozed”) slightly laterally past the lateral edge of the binder layer.

Such occurrences will typically be rather insignificant; in most embodiments any such adhesive deformation will not, for example, change the areal density of the discrete islands of retroreflective laminate by more than 5, 10, or 15%.

In the present approach, a pre-made retroreflective laminate 50 comprising at least a binder layer 60 and an adhesive layer 63, is brought together with a breathable fabric 10 so that the adhesive layer contacts a major surface 12 of the breathable fabric 10, in desired regions 14 of the fabric. (Other regions 15 of the fabric may be left as-is, without a retroreflective laminate disposed therein). The application of e.g. heat and/or pressure causes the adhesive 63 to bond to the fabric 10 so as to dispose discrete islands 21 of laminate 50 on surface 12 of fabric 10.

The process of bringing a laminate 50 and a breathable fabric 10 together with the use of appropriate heat and/or pressure can be as achieved e.g. by a pair of lamination tools. In some embodiments the pair of lamination tools may take the form of rolls of a nip-roll apparatus. Such an apparatus might comprise a first backing roll that supports the retroreflective laminate and a second backing roll that supports the fabric, with a suitable gap established at the point of closest approach of the surfaces of the first and second backing rolls. The surfaces of each backing roll may be chosen with any suitable hardness; for example, the surface may be steel or other metal, or may be e.g. equipped with a coating or sleeve of e.g. silicone rubber or the like, of any suitable thickness and durometer.

However, in some embodiments the lamination may be performed by placing the retroreflective laminate and the breathable fabric into a platen press and pressing them together at a suitable temperature and/or pressure. Such a process will be a batch process rather than a roll-to-roll process. Such an approach may be advantageous in allowing the use of fabric that has already been at least partially cut into the shape of a garment, which might be difficult with a nip-roll system. It is noted in passing that the piece of fabric to which the retroreflective laminate (often multiple pieces of laminate) is attached may itself form a garment, e.g. after any final cutting or finishing process. However, in some embodiments a garment may be formed by taking two or more pieces of fabric, at least one of which bears one or more retroreflective laminates, and joining the pieces of fabric together e.g. by sewing. Any such arrangements are encompassed by the approaches disclosed herein.

In use of a platen press, one or both platens may be controlled to a desired temperature (e.g. 160-180 degrees C.). The platens may be brought together with a suitable pressure (e.g. 40-60 psi) and for a suitable time (e.g. from 5, 10, or 15 seconds, up to 60, 40 or 20 seconds). The platens may then be separated and (after waiting for the items to cool to a sufficient extent that the bond between the adhesive and the fabric is adequately established) the breathable fabric, bearing one or more pieces of retroreflective laminate adhesively bonded thereto, may be removed. Suitable presses for such operations may be of the general type available e.g. from Yourway Machinery Co., Ltd., Taiwan.

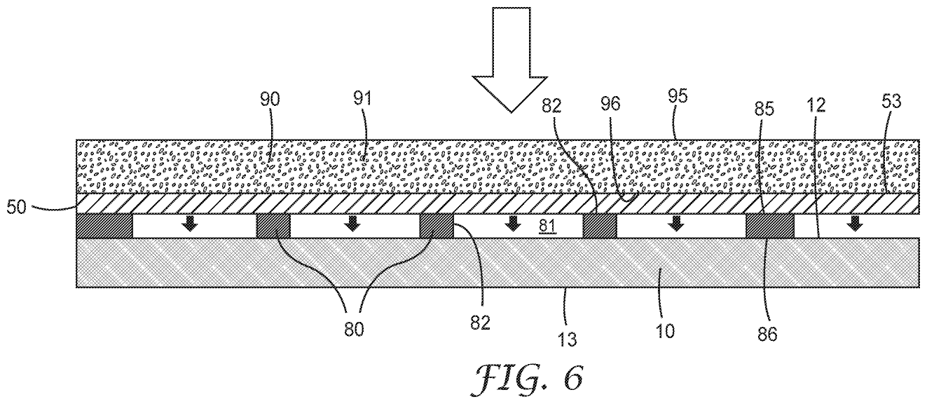

The herein-disclosed process is directed toward producing a breathable fabric with a retroreflective laminate thereon in the form of discrete islands. Various approaches and process conditions, e.g. used in combination, can enable this to be achieved. One general approach has been found to yield advantageous results. With reference to FIG. 6, this approach involves the use of a stencil 80 through which retroreflective laminate 50 is laminated onto fabric 10. By definition, a stencil will be a generally sheetlike item (with a length and width that are much greater than the thickness) that comprises solid portions 82 that define and circumscribe numerous through-openings 81. In a lamination process, stencil 80 will be positioned between the retroreflective laminate 50 and the breathable fabric 10 to which the laminate 50 is to be attached, with the adhesive of the laminate facing toward the fabric.

When, during the lamination process, the retroreflective laminate is pressed against the outward surface 85 of stencil 80 (as shown by the large block arrow in FIG. 6), local areas of the laminate can deform (bulge) into the through-openings 81 of the stencil (as shown by the small block arrows in FIG. 6). This can be carried out so that the surface of the adhesive of the laminate contacts, and bonds to, the surface 12 of fabric 10 that is exposed at the inward ends of the through-openings 81 of stencil 80. When the lamination process is over and fabric 10 is separated from stencil 80 (e.g. when stencil 80 is peeled off of the outward major surface 12 of breathable fabric 10), the areas of the adhesive of the laminate that were bonded to fabric 10 (along with the binder that is atop this area of adhesive), will remain with fabric 10. That is, these areas of the adhesive and the binder material will separate from the adhesive and binder material respectively surrounding them, so that these local areas of the laminate remain bonded to the fabric in the form of discrete islands. Conversely, in areas in which the solid material of the stencil was present, the laminate will be removed along with the stencil. The result will be an arrangement of the general type shown in FIG. 4, in which a fabric 10 exhibits discrete islands 21 of retroreflective laminate, separated by gaps 22 in which no retroreflective laminate is present.

The composition, physical properties (e.g. stiffness), and/or surface properties of the fabric, along with the properties of the adhesive, can be chosen to enhance the ability of the adhesive to bond to the fabric to achieve the effects described above.

It has already been discussed that a retroreflective laminate as disclosed herein will be unsupported, meaning that it does not include any supporting layer such as a polymeric film or fabric layer. It can now be understood that the absence of such a supporting layer will make it easier for the laminate to deform into and through the through-openings of the stencil. (The composition of the binder layer and the adhesive layer can also be chosen e.g. to be relatively elastomeric, deformable, etc., to further enhance this ability.) Still further, the lamination process can be carried out with a retroreflective laminate that is “linerless”. That is, any liner that is present on the laminate as received, will be removed before the lamination process. This obviously includes any liner that may have been present to protect the adhesive (e.g. if the adhesive was sufficiently tacky to require the use of a liner for handling and storage).

However, if there is a “backside” liner (that is, a liner on the opposite side of the binder layer from the adhesive, i.e., on the outer side of the retroreflective laminate), it must also be removed before lamination. (The position that would be occupied by such a liner, had the liner not been removed before lamination, is indicated by reference numeral 74 in FIG. 5.) This goes against conventional practice in the production of retroreflective articles and the bonding of such articles to fabrics. Typically, retroreflective articles that comprise microspheres as disclosed herein, are built starting with a liner (often called a carrier). In conventional practice, such a liner is softened (e.g. by heating) and a multiplicity of transparent microspheres are partially embedded into the liner. A reflective layer (e.g. a metal coating) is then applied to the exposed portions of the microspheres. A binder precursor (e.g. a polymeric resin) is then coated onto the liner, covering the exposed portions of the microspheres, and is hardened to form the binder layer. An adhesive layer is then deposited atop the binder layer. The resulting article is then stored until such time as it is to be attached to a fabric.

To perform the attachment, the article, with the liner still present, is positioned on a fabric with the adhesive in contact with the fabric. The resulting stack is then heated to bond the adhesive to the fabric. This entire process is typically carried out with the original liner (carrier) still present. Only after the article is bonded to the fabric is the liner/carrier removed.

Such a process, as conventionally known in the art, has the advantages that the liner/carrier can stabilize the retroreflective article and in particular can minimize any stretching or warping of the retroreflective article during handling. Such considerations may be important e.g. for large-scale operations that involve roll-to-roll handling of the retroreflective article. However, the present work has revealed that for lamination operations of the type disclosed herein, it is possible to remove any such liner/carrier from the retroreflective laminate before the laminate is bonded to the fabric without undue deformation or damage to the laminate. And, the present discussions make it clear that the absence of any such liner/carrier on a laminate will significantly reduce the stiffness of the laminate and will make it easier for the laminate to deform into and through the apertures of the fabric.

If a retroreflective laminate is particularly weak or otherwise difficult to handle in the absence of a backside liner/carrier, a slightly modified lamination procedure may be used. For example, the laminate may be placed on a desired stencil with a backside liner still in place. Mild heat and/or pressure can then be applied to tack the laminate in place on the stencil. With the laminate tacked to the stencil in this manner, the backside liner can be removed, after which a full lamination process (with temperature and/or pressure as described herein) can be performed to laminate the retroreflective laminate to the fabric. In a modification of this approach, a laminate may be bonded to a stencil to a sufficient extent that the stencil itself may serve as a de facto liner that renders the retroreflective laminate sufficiently handleable that any previously-present liner may be removed. Thus in embodiments of this type, the condition that the lamination will be a “linerless” lamination does not preclude the presence of a stencil to which the retroreflective laminate has been attached so that the stencil can serve as a liner. (Rather, such arrangements preclude the presence of any additional liner that does not also serve as a stencil.) It will be appreciated that such a liner/stencil will differ from conventional release liners as typically used with adhesives, in that the liner/stencil does not need to be, and in many embodiments will not be, removable from the adhesive.

Thus, in some embodiments a retroreflective laminate can be supplied (for lamination to a fabric) in the form of an article that is equipped with a liner/stencil that is e.g. non-removably bonded to the adhesive of the retroreflective laminate. In such embodiments, such an article may comprise a retroreflective laminate comprising an adhesive layer and a binder layer bearing retroreflective elements, and may further comprise a non-removable liner in the form of a stencil, the liner/stencil being in contact with the adhesive layer.

Beyond the above-discussed guidelines, another approach has been found to yield particularly advantageous results. This is the use of a compliant pad behind the retroreflective laminate, in the lamination process. It has been found that the presence of such a compliant pad can significantly enhance the ability of the laminate to deform into and through the through-openings of the stencil. Thus as shown in exemplary embodiment in FIG. 6, in some embodiments a compliant pad 90 may be present behind the retroreflective laminate 50, e.g. between laminate 50 and a platen of a platen press that is used to perform the lamination. In such cases, a major surface 95 of pad 90 may face toward the platen, with an opposing major surface 96 of pad 90 facing toward, e.g. contacting, outward major surface 53 of laminate 50.

By a compliant pad is meant a pad that exhibits a Shore OO hardness of 100 or less. In various embodiments, such a pad may exhibit a Shore OO hardness of less than 90, 80, 70, 60, 50, 40, 30, or 20. In some embodiments, such a pad may exhibit a Shore OO hardness of at least 5, 10, or 15. Such a compliant pad may be made of any suitable material, e.g. silicone rubber, to ensure that the binder (and the transparent microspheres) will not adhere to the pad under the conditions of lamination. In various embodiments, such a pad may be a dense material (e.g. a silicone rubber lacking voids or porosity); or, the pad may be e.g. a foam or fibrous material, e.g. a woven or nonwoven textile or a leather material, as long as it exhibits the necessary compliance. The above-cited Shore values will be measured at room temperature (21 degrees C.). It will be appreciated that the actual hardness of any such pad may change with temperature, e.g. the pad may become slightly softer at the temperatures used in lamination. Any such phenomena will be taken into account when choosing a pad with a particular room temperature Shore value.

As noted, in some embodiments, a lamination process as disclosed herein may be carried out with a platen press. In such a lamination process, either or both of the platens (the platen behind the laminate and compliant pad, and/or the platen behind the breathable fabric) may be heated. If the platen behind the laminate and the compliant pad is heated, it may be beneficial that the compliant pad comprise a high thermal conductivity (e.g., higher than that of conventional silicone rubbers) so that the heat may be transmitted through the pad. Compliant pads with enhanced thermal conductivity (e.g. by way of incorporating thermally-conductive fillers 91 into a silicone rubber) are available from a number of sources. Such compliant pads include e.g. various products available from T-Global Technology, Lutterworth, UK, under the general trade designations TG-A and TG-AK. Such pads may exhibit a thermal conductivity in the range of e.g. 2-18 W/mK (in contrast to conventional silicone rubbers, which typically exhibit a thermal conductivity in the range of 0.2-0.4 W/mK). If the platen behind the fabric is heated, it may not be necessary that the compliant pad that is behind the retroreflective laminate exhibit a high thermal conductivity, although this may be arranged if desired.

In various embodiments, such a compliant pad may be at least 1.0, 1.5, 2.0, 3.0, 4.0, 6.0, or 8.0 mm in total thickness. In further embodiments such a pad may be at most 10, 7, 5 or 2.5 mm thick. The thickness of the pad may impact the thermal conductivity that may be required of the pad; i.e., a relatively thin pad may not need a very high thermal conductivity.

Such arrangements may be varied as desired. For example, two compliant pads may be used, one positioned behind the retroreflective laminate and one behind the breathable fabric. Either or both platens may be heated, and the choice of conventional compliant pads versus compliant pads with enhanced thermal conductivity can be made accordingly. Work so far has shown that a single (heat-conductive) compliant pad, located behind the retroreflective laminate, can provide adequate results. However, the work has indicated that providing an additional compliant pad, behind the breathable fabric, may provide somewhat superior results. It is possible that a compliant pad positioned behind the breathable fabric may serve to urge the fabric into the through-openings in the stencil so as to be more easily contacted by the adhesive of the retroreflective laminate and thus may enhance the effects disclosed herein.

Thus in some embodiments, one or more compliant pads may be inserted into a platen press along with the laminate, stencil and fabric to form a stack. In some such embodiments the pad may be used numerous times (e.g. more than 10). In other embodiments, the pad may only be used a few times (e.g. 10, 5, or 2 uses, or even a single use), e.g. it may take the form of a piece of compliant fabric that is used and then disposed or recycled. In some embodiments, it may be possible to attach a compliant pad to a platen of the press so that the pad can be used multiple times without being removed from the press. The composition of the pad (or at least the composition of a major surface of the pad that will face the binder layer) may be chosen so that the pad and binder layer will not adhere to each other under the conditions used in laminating the retroreflective laminate to the fabric.

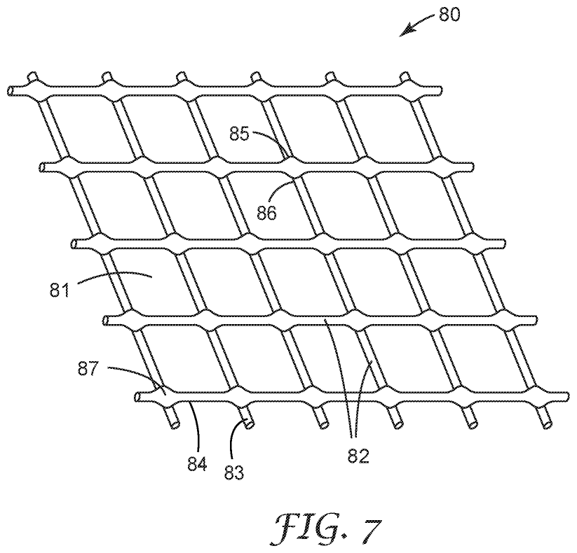

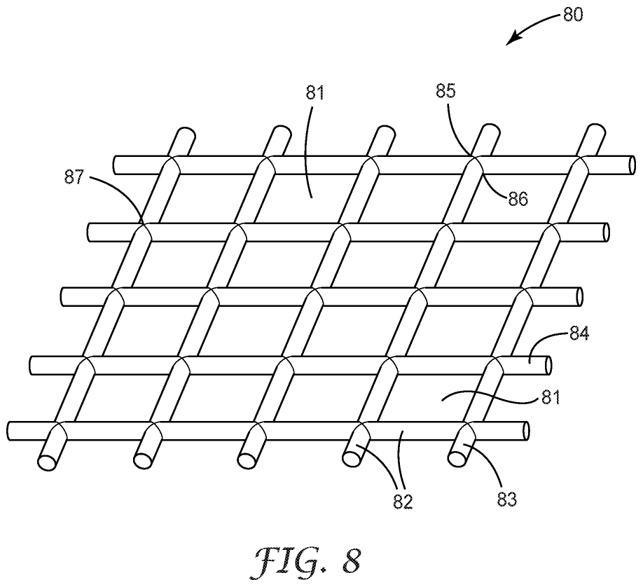

Any stencil that has suitable properties to achieve the effects disclosed herein may be used. In some convenient embodiments, such a stencil 80 may take the form of a netting or screen (the term “netting” will be used for convenience here) as shown in exemplary embodiment in FIGS. 7 and 8. Such a netting may comprise solid members 82 that define through-openings 81. In some embodiments such members may be arranged in two major groups, e.g. with a first set of members 83 oriented in a first direction, and a second set of members 84 oriented in a section direction, with the sets of members meeting at junctions 87. Such nettings may provide through-openings 81 that are e.g. rectangular, square, rhombus or lozenge (e.g. diamond)-shaped. However, many variations are possible, which involve members that are oriented in more than two directions, members that meet at relatively complex junctions, and so on. It can be appreciated from inspection of the photograph of a Working Example sample in FIG. 2, that in that particular instance a stencil was used in the form of a honeycomb type netting that, while still providing generally diamond-shaped through-holes, was slightly more complex than the exemplary nettings shown in FIGS. 7 and 8.

The dimensions of the stencil material will establish the corresponding dimensions of the discrete islands of retroreflective laminate that are provided on the fabric. That is, the shape and size of the discrete islands will correspond closely to the shape and size of the through-openings 81 in the stencil. Similarly, the arrangement and dimensions of the gaps 22 between the discrete islands will correspond closely to the arrangement and dimensions of the solid members 82 of the stencil. The size of through-openings 81 may correspond to any of the sizes (in square mm) previously recited for the discrete islands. Similarly, the width of solid members 82 may correspond to any of the widths previously recited for gaps 22. The thickness of the stencil may be any suitable value, e.g. from at least 0.15, 0.20, or 0.25 mm, to at most 1.0, 0.8, 0.6, 0.4, or 0.3 mm.

The composition and resulting properties of the stencil, e.g. netting, should be chosen to achieve the desired effects. Obviously the stencil material must maintain its integrity under the conditions of heat and pressure used in the lamination. Beyond this, the stencil material should be able to assist in, or at least allow, the previously-described separation of the areas of binder and adhesive that have come into contact with, and bonded to, the fabric, from the surrounding areas of binder and adhesive that are in contact with the stencil. Thus, it may be helpful that the stencil material is actually able to penetrate through the softened binder and/or adhesive to some extent under the conditions of heat and pressure used in the lamination. It may also be helpful, although not necessarily required, that the adhesive is able to bond to the surface of the stencil material. In some embodiments, the stencil material may be a suitable metal, e.g. aluminum or steel. However, in many convenient embodiments the stencil material may be an organic polymeric material, e.g. nylon or the like.

In some embodiments, after stencil 80 and fabric 10 are separated to leave behind the discrete islands 21 of retroreflective laminate 50 on the outer major surface 12 of fabric 10, fabric 10 and discrete islands 21 may be subjected to a brief post-lamination step. Such a post-lamination (which may not necessarily involve temperatures and/or pressures as high as in the primary lamination step) may, for example, ensure that the edges 23 of the discrete islands of laminate 50 are securely affixed in place on surface 12 of fabric 10.

Additional descriptions of various components (e.g. binder, transparent microspheres, and so on) will be briefly provided. However, such components are described in detail in numerous patent documents and so will not be described in detail herein. As noted earlier, binder layer 60 holds and retains transparent microspheres 70 and presents them in such a manner that they can achieve a retroreflective effect. Binder layer 60 also imparts retroreflective laminate 50 with sufficient mechanical integrity so that laminate 50 can, in the absence of any additional supporting layer, be processed and handled, e.g. laminated to a fabric. In various embodiments, binder layer 60 may exhibit an average thickness of from e.g. 30 to 250 micrometers. Under conditions of lamination as disclosed herein, binder layer 60 will soften and become deformable to an extent to allow the herein-described effects to be achieved. Specifically, the binder layer should be able to deform into an aperture in the manner described; and, it must be able to be sundered apart at the locations where part of the binder is bonded to the breathable fabric and part of the binder remains with (e.g. is bonded to) the netting. Thus, in many embodiments, the binder may be a thermoplastic material rather than a thermoset material (although in some particular embodiments, it might be a thermoset (networked) material that is nevertheless weak enough at the lamination temperature, to allow the binder to deform and separate in the manner described herein).

Binder layer 60 may be of any suitable composition. In some embodiments, binder layer 60 may be a composition of the general type disclosed in U.S. Provisional Patent Application No. 62/785,326 and in resulting PCT application WO2020/136531, which is incorporated by reference in its entirety herein. Such compositions may comprise e.g. styrenic block copolymers in combination with one or more suitable tackifiers, e.g. tackifiers comprising non-carbon hetero-atom functionality. In some embodiments, binder layer 60 may be a composition of the general type disclosed in U.S. Provisional Patent Application No. 62/785,344 and in resulting PCT application WO2020/136567, which is incorporated by reference in its entirety herein. Such compositions may comprise e.g. at least one tackifier and at least one elastomer selected from at least one of natural rubbers and synthetic rubbers (e.g. an elastomeric styrenic block copolymer).

In some embodiments, binder layer 60 may be of a composition of the general type disclosed in U.S. Provisional Patent Application No. 62/522,279 and resulting PCT application WO2018/236783, and in U.S. Provisional Patent Application No. 62/527,090 and resulting PCT application WO2019/003158, all of which are incorporated by reference in their entirety herein. These documents describe various curable (meth)acrylate formulations that may be useful for forming a “bead bond layer” (e.g., i.e., a binder layer). For example, the US'090 document describes compositions that may comprise polymerized units of one or more (meth)acrylate ester monomers derived from an alcohol containing 1 to 14 carbon atoms, and at least one of urethane acrylate polymer or acrylic copolymer. The US'279 document describes compositions that may comprise polymerized units of one or more (meth)acrylate ester monomers derived from an alcohol containing 1 to 14 carbon atoms, and polyvinyl acetal resin. Still other potentially suitable binder compositions are described in U.S. Patent Application Publications 2017/0276844, 2020/0264352, and 2020/0264349, all of which are incorporated by reference in their entirety herein.

Adhesive layer 63 of retroreflective laminate 50 may be of any suitable type, as discussed earlier herein. Various adhesives are described in U.S. Patent Application Publication No. 2017/0276844, which is incorporated by reference in its entirety herein. It is noted that the composition of an adhesive of a retroreflective laminate may be chosen in view of the composition of the breathable fabric to which it is to be laminated. For example, if the breathable fabric is e.g. a polyester or polyester blend, the adhesive may be a polyester-based adhesive. Such measures can ensure that the adhesive will bond adequately to the fabric.

It may be desirable that the compositions of the various items be chosen so that the bond between adhesive 63 and binder layer 60 is sufficiently strong (e.g. at least as strong as the bond that is established between adhesive 63 and fabric 10) that adhesive 63 will not separate from binder layer 60. In other words, the goal is that both adhesive 63 and binder layer 60 (rather than only adhesive 63) will transfer to the fabric.

Transparent microspheres 70 as used in a retroreflective laminate may be of any suitable type. The term “transparent” is generally used to refer to a body (e.g. a glass microsphere) or substrate that transmits at least 50% of electromagnetic radiation at a selected wavelength or within a selected range of wavelengths. In various embodiments, transparent microspheres may be made of e.g. inorganic glass, and/or may have a refractive index of e.g. from 1.7 to 2.0. In various embodiments, the transparent microspheres may have an average diameter of at least 20, 30, 40, 50, 60, 70, or 80 microns. In further embodiments, the transparent microspheres may have an average diameter of at most 200, 180, 160, 140 120, 100, 80, or 60 microns. The vast majority (e.g. at least 90% by number) of the microspheres may be at least generally, substantially, or essentially spherical in shape. However, it will be understood that microspheres as produced in any real-life, large-scale process may comprise a small number of microspheres that exhibit slight deviations or irregularities in shape. Thus, the use of the term “microsphere” does not require that these items must be e.g. perfectly or exactly spherical in shape.

In various embodiments, in a retroreflective laminate 50, a microsphere 70 may be partially embedded in binder layer 60 so that on average, from 15, 20 or 30 percent of the diameter of the microsphere, to about 80, 70, 60 or 50 percent of the diameter of the microsphere, is embedded within the binder layer. Typically, the microspheres will be at least slightly laterally spaced apart from each other although occasional microspheres may be in lateral contact with each other. In various embodiments, the microspheres may be present on the binder at a packing density of at least 30, 40, 50, 60 or 70 percent, and/or at most 80, 75, 65, 55 or 45 percent.

In some embodiments, a minor reflective layer 73 operating in combination with a transparent microsphere 70 to provide a retroreflective element may comprise a metal layer, e.g. a single layer, or multiple layers, of vapor-deposited metal (e.g. aluminum or silver), or of metal alloy. In some embodiments, a minor reflecting layer may take the form of a dielectric reflecting layer, comprising an optical stack of pairs of high and low refractive index sublayers that are arranged in series along the optical path to provide reflective properties in combination. In various embodiments, one, two, three, or more pairs of high/low refractive index sublayers may be present. Dielectric reflecting layers are described in further detail in U.S. Patent Application Publication No. 2017/0131444, which is incorporated by reference in its entirety herein.

In some embodiments at least some of the retroreflective elements (e.g. transparent microspheres in combination with reflective layers) of a herein-disclosed retroreflective laminate 50 may comprise at least one minor color layer. The presence of color layers in at least some of the retroreflective light paths of a retroreflective laminate can allow the laminate to comprise at least some areas that exhibit colored retroreflected light, irrespective of the color(s) that these areas (or any other areas of the laminate) exhibit in ambient (non-retroreflected) light. Color layers are described in further detail e.g. in U.S. Provisional Patent Application No. 62/675,020 and the resulting International Patent Application Publication WO2019/084297, both of which are incorporated by reference in their entirety herein. All optical layers such as e.g. color layers and reflective layers and sublayers thereof, will typically be extremely thin (e.g. less than 5 microns) and non-structural and thus will be considered to be “minor” layers as discussed earlier herein. In some embodiments the retroreflective laminate may be configured to exhibit a particular color in ambient (non-retroreflected) light, irrespective of any color that is exhibited in retroreflected light. This may be achieved for example by loading the binder layer with any desired pigment, dye or the like.

Various products comprising a binder layer bearing transparent microspheres and reflective layers, and an adhesive layer, but without having any supporting layer, are commercially available and may serve as a retroreflective laminate as disclosed herein. Such products include e.g. various products available from 3M Company, St. Paul MN, under the trade designations SCOTCHLITE REFLECTIVE MATERIAL TRANSFER FILM C725, C750, C750R, C790, 8712, 8725, 5510, and 5807. Some such products, as supplied, may include an adhesive-side liner that will be removed before lamination. Some such products, as supplied, may include a backside (outer) liner. According to the disclosures herein, such a liner should be removed before lamination (or, the product may be e.g. tacked to a stencil after which the backside liner is removed for full lamination, as described elsewhere herein.)

After a retroreflective laminate 50 as disclosed herein is produced or obtained, the laminate may be stored in any suitable format, and/or may be further processed as desired. In some convenient embodiments, a temporary carrier (liner), if present, can be left in place until such time as the carrier is removed prior to lamination as discussed above. The retroreflective laminate may of course be e.g. cut to any desired shape in preparation for being laminated to a breathable fabric.

In many embodiments, one or more retroreflective laminates 50 may be laminated directly to a breathable fabric 10 that will provide a garment 1. However, the approaches disclosed herein are not necessarily limited to “direct” disposition of the laminate onto a garment. Thus in some instances, the approaches disclosed herein may be used e.g. to provide an article in the form of a piece of “trim” of the general type mentioned previously. In such embodiments, such a “trim” piece, comprising a breathable fabric bearing a retroreflective laminate as described herein, may be coupled to a garment (or to any other object) e.g. by sewing, by use of an adhesive, or by any other suitable method.

By a retroreflective laminate is meant a laminate that exhibits a Coefficient of Retroreflectivity of at least 50 candela per lux per square meter, measured (at 0.2 degrees observation angle and 5 degrees entrance angle) in accordance with the procedures outlined in U.S. Patent Application Publication Nos. 2017/0276844 and 2017/0293056. In various embodiments, such a retroreflective laminate may exhibit a Coefficient of Retroreflectivity of at least 100, 200, 250, 330, 350, or 450 candela per lux per square meter when tested according to such procedures. In instances in which individual discrete islands of retroreflective laminate are too small to be easily evaluated, the retroreflective performance of a macroscopic region of a garment that bears such islands may be evaluated. In various embodiments, such a region may exhibit a Coefficient of Retroreflectivity of any of the above-listed values.

In various embodiments, retroreflective laminates (and/or garments bearing such laminates) as disclosed herein may meet the photometric and/or physical performance requirements for retroreflective materials per ANSI 107-2015 and/or ISO 20471:2013. (In particular, the fabric of such a garment may exhibit a minimum luminance factor such that the fabric is considered to be fluorescent as defined herein.) In many embodiments, retroreflective laminates as disclosed herein comply with the requirements for the minimum Coefficient of Retroreflection as shown in Table 5 of ANSI 107-2015 (i.e., a so-called “32-angle” test).

In some embodiments, retroreflective laminates as disclosed herein may exhibit satisfactory, or excellent, wash durability. In some embodiments such wash durability may be manifested as high R_{A} retention (a ratio between R_{A} after wash and R_{A} before wash) after numerous (e.g. 25) wash cycles conducted according to ISO 6330 Method 2A, as outlined in U.S. Patent Application Publication No. 2017/0276844. In various embodiments, a retroreflective laminate as disclosed herein may exhibit a percent of R_{A} retention of at least 10%, 30%, 50%, or 75% after either of the above-listed washing methods is performed. In various embodiments, a retroreflective laminate as disclosed herein may exhibit any of these retroreflectivity-retention properties in combination with an initial R₄ (before any washing) of at least 100 or 330 candela per lux per square meter, measured as noted above.

### Examples

### Test Methods

Retroreflectivity Measurement

Coefficients of Reflection (RA, at an observation angle of 0.2° and an entrance angle of 5°), reported in units of candelas per lux per square meter (candelas/lux/meter), may be obtained following the methods described in U.S. Patent Application Publication No. 2020/0264350, which is incorporated by reference in its entirety herein. In some cases, samples may be evaluated in a “32-angle” test for the minimum coefficient of retroreflection for the 32 angle combinations as described in Table 5 of ANSI 107-2015, which is often used in the evaluation of e.g. safety apparel.

Color Measurement Color coordinates in ambient light conditions (Y, x, y for fluorescent yellow color, or L*, a*, b* for other colors such as white) may be performed according to the procedures described in the above-cited US '350 Publication.

Wash Durability Test

Wash durability is reported as a percent of R_{A} retention (calculated as a ratio between R_{A} after wash and R_{A} before wash, each measured at an observation angle of 0.2 degrees and an entrance angle of 5 degrees) after indicated (e.g. 25) wash cycles conducted according to the method of ISO 6330 2A. A sample is deemed as “wash durable” under the indicated protocol if the percent retention of R_{A} (calculated as a ratio between R_{A} after wash and R_{A} before wash) after the wash durability test is greater than or equal to 10%.

### Working Examples

Working Example samples were prepared according to the following general procedures. Fluorescent (e.g. orange or yellow) fabrics were obtained by cutting up fluorescent (ANSI 107-2015 compliant) high-visibility safety garments. The fabric (one such example is shown in FIG. 2) was approximately 0.5 mm in thickness and was believed to be breathable, but did not comprise apertures as defined herein.

A retroreflective laminate was obtained from 3M Company in the form of SCOTCHLITE REFLECTIVE MATERIAL TRANSFER FILM 8725. This product comprised a binder layer with reflectorized transparent microspheres partially embedded therein, and an adhesive layer. The product was an unsupported laminate (not including e.g. any kind of fabric layer). The adhesive layer was a polyester-based thermoplastic material (thickness approximately 75 μm) that was believed to have been disposed onto the binder layer by heated lamination. The adhesive layer was nontacky at room temperature and no adhesive-side liner was present. A backside liner, if present (8725 is available in two versions, linerless and with a backside liner), was removed. The thickness of the laminate (including the binder and the adhesive, absent any liner) was approximately 0.15 mm.

A stencil was obtained in the form of a generally hexagonal (honeycomb) netting comprised of an organic polymeric material. The dimensions of the hexagons of the netting were approximately 8 mm along the long axis of the hexagons, by approximately 6 mm along the short axis of the hexagons; the thickness of the netting was approximately 0.32 mm.

A piece of the breathable fabric was placed onto the lower platen of a platen press, followed by the netting. The retroreflective laminate was then placed atop the stencil, adhesive side down. A heat-conductive compliant pad (several mm thick, believed to be made of silicone with a thermally-conductive additive) was then placed atop the retroreflective laminate to complete the stack. The stack was thus of the general type shown in FIG. 6. In general, best results seemed to be obtained by including an additional compliant pad (that did not need to be heat-conductive) below the breathable fabric (between the fabric and the lower platen).

The platen press was a type in which the upper (moving) platen was heated, with the lower (stationary) platen not being temperature-controlled. The upper platen was heated to a stable set point of approximately 160 degrees C. The upper platen was then brought down and the platens were pressed together to a pressure of approximately 60 psi. This was maintained for a dwell time of approximately 20 seconds, after which the press was opened. After a brief wait for the stack to cool, the stack was removed from the press.

After sufficient cooling, the netting was peeled off of the breathable fabric. Discrete dots of laminate (adhesive and binder layer) were observed to have bonded to the sacrificial substrate and thus to have separated from the remainder of the laminate.

The thus-produced Working Example sample was a fluorescent, breathable fabric bearing an unsupported, retroreflective laminate adhesively bonded thereto. A photograph of one such sample is presented in FIG. 5. For this sample, it was estimated that in the macroscopic regions in which the retroreflective laminate was present, the retroreflective laminate was present at an areal density of approximately 80%. In the particular sample shown in FIG. 2, two macroscopic areas of the fabric had retroreflective laminates attached thereto (simultaneously, in the same lamination operation), at right angles to each other and with an overall end of one laminate closely abutted against an overall edge of the other laminate.

The Coefficient of Retroreflectivity (RA, at an observation angle of 0.2° and an entrance angle of 5°), of various samples of retroreflective laminate disposed on fabrics as described above were evaluated. In general the laminates exhibited excellent retroreflectivity (i.e., well above 330 candelas/lux/meter²). A representative sample that was subjected to a “32-angle” test as described above, met the criteria required in ANSI 107-2015.

Various Additional Working Example samples were made in similar manner as described above, using different fabrics, retroreflective laminates, nettings, stencils, compliant pads and so on. Some such fabrics were stretchable fabrics as defined earlier herein. The areas of such fabrics that included discrete islands of retroreflective laminate, were still able to stretch in generally similar manner to the original fabric, such that the overall samples of fabric were still stretchable without being unduly limited in stretching by the areas bearing the retroreflective laminate. Some of the compliant pads that were used were in the form of thin (e.g. less than 1 mm thick) pieces of compliant fabric, and were found to work satisfactorily.

Some samples were tested for Wash Durability according to the procedures presented above. Such samples met the criteria in the ISO 6330 2A standard for both initial retroreflectivity and retention of retroreflectivity after 25 wash cycles.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein, this specification as written will control.

1. A breathable, high-visibility garment comprising:
a breathable fabric comprising at least one macroscopic region comprising a multiplicity of discrete islands of unsupported, retroreflective laminate that are each adhesively bonded to an outer major surface of the breathable fabric by way of an adhesive of the unsupported, retroreflective laminate,
wherein in the at least one macroscopic region, the discrete islands of retroreflective laminate are present at an areal density of from 60% to 95% and exhibit an average size of from 1 square mm to 100 square mm, and wherein gaps between edges of nearest-neighbor discrete islands are, on average, from 0.3 mm to 2.0 mm wide.

2. The breathable, high-visibility garment of claim 1 wherein the retroreflective laminate exhibits a Coefficient of Reflection (RA) at an observation angle of 0.2° and an entrance angle of 5° of at least 330 candelas per lux per square meter (candelas/lux/meter²).

3. The breathable, high-visibility garment of claim 1 wherein the retroreflective laminate comprises a binder layer that is positioned outward of the adhesive of the retroreflective laminate and comprises transparent microspheres that are partially embedded in the binder layer so as to exhibit outwardly-exposed portions and embedded portions and that comprise reflective layers on the major surfaces of the embedded portions.

4. The breathable, high-visibility garment of claim 3 wherein the adhesive is present in the form of an adhesive layer that is different from the binder layer and wherein no major layers are present in the retroreflective laminate other than the binder layer and the adhesive layer.

5. The breathable, high-visibility garment of claim 1 wherein the breathable fabric is fluorescent.

6. The breathable, high-visibility garment of claim 1 wherein the garment does not comprise any retroreflective element in the form of a supported retroreflective laminate that is attached to the garment and does not comprise any retroreflective element, supported or unsupported, that is a directly-coated retroreflective layer, a transparent microsphere-bearing adhesive layer, or a retroreflective layer that is bonded to the garment by way of an adhesive layer that is disposed on the garment prior to the retroreflective layer being bonded to the adhesive layer.

7. The breathable, high-visibility garment of claim 1 wherein at least 70% of the at least one macroscopic region of the breathable fabric in which the discrete islands of retroreflective laminate are present, is in the form of a single layer of the breathable fabric with no other layer of fabric being present.

8. The breathable, high-visibility garment of claim 1 wherein the breathable fabric is an unapertured fabric.

9. The breathable, high-visibility garment of claim 8 wherein the areas of the breathable fabric on which the discrete islands of retroreflective laminate are present, are occluded by the retroreflective laminate.

10. The breathable, high-visibility garment of claim 1 wherein the fabric is an apertured fabric.

11. The breathable, high-visibility garment of claim 10 wherein at least some apertures are in the form of perforations.

12. The breathable, high-visibility garment of claim 11 wherein at least some of the apertures are not occluded by the retroreflective laminate.

13. The breathable, high-visibility garment of claim 1 wherein the garment is a vest, shirt, jacket, trousers, or coverall that meets all requirements of ANSI 107-2015.

14. The breathable, high-visibility garment of claim 1 wherein the breathable fabric is a stretchable fabric that is reversibly stretchable to an elongation of at least 50%, including in the at least one macroscopic region of the fabric that comprises the multiplicity of discrete islands of unsupported, retroreflective laminate.

15. A method of adhesively laminating a retroreflective laminate to a major surface of a fabric to provide discrete islands of unsupported, retroreflective laminate on the major surface of the fabric, the method comprising:
disposing, in a heated press, a stack comprising,
a fabric with first and second opposing major surfaces,
a stencil comprising through-openings,
a linerless, unsupported, retroreflective laminate comprising an adhesive layer that faces the stencil,
and,
a compliant pad comprising a Shore OO Hardness of 100 or less, the compliant pad being positioned between the retroreflective laminate and a platen of the heated press;
closing the heated press under pressure so that the compliant pad urges portions of the retroreflective laminate to enter the through-openings of the stencil and to penetrate through the through-openings so as to contact the first major surface of the fabric that is exposed at the bottom of the apertures,
adhesively bonding portions of the adhesive layer of the retroreflective laminate that are in contact with the first major surface of the fabric, to the first major surface of the fabric;
and,
opening the heated press and separating the stencil from the fabric so that portions of the retroreflective laminate that are adhesively bonded to the first major surface of the fabric remain as discrete islands on the first major surface of the fabric.

16. The method of claim 15 wherein the compliant pad is a heat-conductive compliant pad with a thermal conductivity of at least 4.0 W/mK and wherein the heated press is configured so that heat is supplied at least through a platen of the press that is in contact with the heat-conductive compliant pad.

17. The method of claim 15 wherein the compliant pad comprises a thermal conductivity of less than 0.2 W/mK and wherein the heated press is configured so that heat is supplied at least through a platen of the press that is in contact with the fabric.

18. The method of claim 15 wherein a first compliant pad comprising a Shore OO Hardness of 100 or less is positioned between the retroreflective laminate and a first platen of the heated press and wherein a second compliant pad comprising a Shore OO Hardness of 100 or less is positioned between the fabric and a second platen of the heated press.

19. The method of claim 15 wherein the fabric is a piece of fabric that has been at least partially cut into the form of a garment prior to being placed in the heated press; and, wherein the method does not include a step of attaching the fabric with the retroreflective laminate adhesively bonded thereto to a separate piece of fabric that is larger than the fabric and that has been at least partially cut into the form of a garment.

20. The method of claim 15 wherein the stencil is in the form of a liner/stencil that was previously bonded to the adhesive layer of the retroreflective laminate, prior to the process of adhesively laminating the retroreflective laminate to the major surface of the fabric.
